(19) United States
(12) Patent Application Publication
(10) Pub. No.: US 2025/0200449 A1
(43) Pub. Date: Jun. 19, 2025

(54) INFORMATION PROCESSING SYSTEM, INFORMATION PROCESSING METHOD, AND NON-TRANSITORY RECORDING MEDIUM

(71) Applicant: NEC Corporation, Minato-ku, Tokyo (JP)

(72) Inventor: Yuto Misaka, Tokyo (JP)

(73) Assignee: NEC Corporation, Minato-ku, Tokyo (JP)

(21) Appl. No.: 18/846,335

(22) PCT Filed: Mar. 18, 2022
(86) PCT No.: PCT/JP2022/012771

§ 371 Date: Sep. 12, 2024

(51) Int. Cl. G06Q 10/02; G06F 21/32

(52) U.S. Cl. CPC G06Q 10/02; G06F 21/32

(57) ABSTRACT

An information processing system includes: a holding information acquisition unit that acquires, from a portable terminal used by a first user, holding state information indicating a holding state of the portable terminal; and an output unit that outputs the holding state information to an information processing terminal used by a second user who is different from the first user. According to the information processing system, it is possible to properly output the holding state of the portable terminal by the first user, to the second user who is different from the first user.

### TECHNICAL FIELD

This disclosure relates to technical fields of an information processing system, an information processing method, and a recording medium.

### BACKGROUND ART

A known system of this type performs predetermined reservation processing by using a terminal apparatus. For example, Patent Literature 1 discloses that a conference/meeting room is reserved by using a wearable PC. Patent Literature 2 discloses reservation of music for karaoke. Patent Literature 3 discloses that a wearable terminal may be used as a terminal apparatus used to reserve a store.

### CITATION LIST

### Patent Literature

Patent Literature 1: JP2021-082245A
Patent Literature 2: JP2008-076699A
Patent Literature 3: JP2017-033343A

### SUMMARY

### Technical Problem

This disclosure aims to improve the techniques/technologies disclosed in Citation List.

### Solution to Problem

An information processing system according to an example aspect of this disclosure includes: a holding information acquisition unit that acquires, from a portable terminal used by a first user, holding state information indicating a holding state of the portable terminal; and an output unit that outputs the holding state information to an information processing terminal used by a second user who is different from the first user.

An information processing method according to an example aspect of this disclosure includes: acquiring, from a portable terminal used by a first user, holding state information indicating a holding state of the portable terminal; and outputting the holding state information to an information processing terminal used by a second user who is different from the first user.

A recording medium according to an example aspect of this disclosure is a recording medium on which a computer program that allows at least one computer to execute an information processing method is recorded, the information processing method including: acquiring, from a portable terminal used by a first user, holding state information indicating a holding state of the portable terminal; and outputting the holding state information to an information processing terminal used by a second user who is different from the first user.

### BRIEF DESCRIPTION OF DRAWINGS

FIG. 1 is a block diagram illustrating a hardware configuration of an information processing system according to a first example embodiment.

FIG. 2 is a block diagram illustrating a functional configuration of the information processing system according to the first example embodiment.

FIG. 3 is a flowchart illustrating a flow of an information output operation by the information processing system according to the first example embodiment.

FIG. 4 is a block diagram illustrating a functional configuration of an information processing system according to a second example embodiment.

FIG. 5 is a flowchart illustrating a flow of an information output operation by the information processing system according to the second example embodiment.

FIG. 6 is a block diagram illustrating a functional configuration of an information processing system according to a third example embodiment.

FIG. 7 is a flowchart illustrating a flow of an information output operation by the information processing system according to the third example embodiment.

FIG. 8 is a block diagram illustrating a functional configuration of an information processing system according to a fourth example embodiment.

FIG. 9 is a block diagram illustrating a functional configuration of an information processing system according to a modified example of the fourth example embodiment.

FIG. 10 is a flowchart illustrating a flow of a reservation cancellation operation by the information processing system according to the fourth example embodiment.

FIG. 11 is a block diagram illustrating a functional configuration of an information processing system according to a fifth example embodiment.

FIG. 12 is a flowchart illustrating a flow of a reservation cancellation operation by the information processing system according to the fifth example embodiment.

FIG. 13 is a block diagram illustrating a functional configuration of an information processing system according to a sixth example embodiment.

FIG. 14 is a flowchart illustrating a flow of a reservation information generation operation by the information processing system according to the sixth example embodiment.

FIG. 15 is a flowchart illustrating a flow of a reservation cancellation operation by the information processing system according to the sixth example embodiment.

FIG. 16 is a schematic diagram illustrating an example of a tag terminal and a tag type terminal in the information processing system according to the sixth example embodiment.

FIG. 17 is a block diagram illustrating a functional configuration of an information processing system according to a seventh example embodiment.

FIG. 18 is a flowchart illustrating a flow of a reservation corresponding operation by the information processing system according to the seventh example embodiment.

FIG. 19 is a diagram illustrating a display example of reservation information in the information processing system according to the seventh example embodiment.

FIG. 20 is a block diagram illustrating a functional configuration of an information processing system according to an eighth example embodiment.

FIG. 21 is a flowchart illustrating a flow of an information output operation by the information processing system according to the eighth example embodiment.

FIG. 22 is a block diagram illustrating a functional configuration of an information processing system according to a ninth example embodiment.

FIG. 23 is a flowchart illustrating a flow of a reservation corresponding operation by the information processing system according to the ninth example embodiment.

### DESCRIPTION OF EXAMPLE EMBODIMENTS

Hereinafter, an information processing system, an information processing method, and a recording medium according to example embodiments will be described with reference to the drawings.

### First Example Embodiment

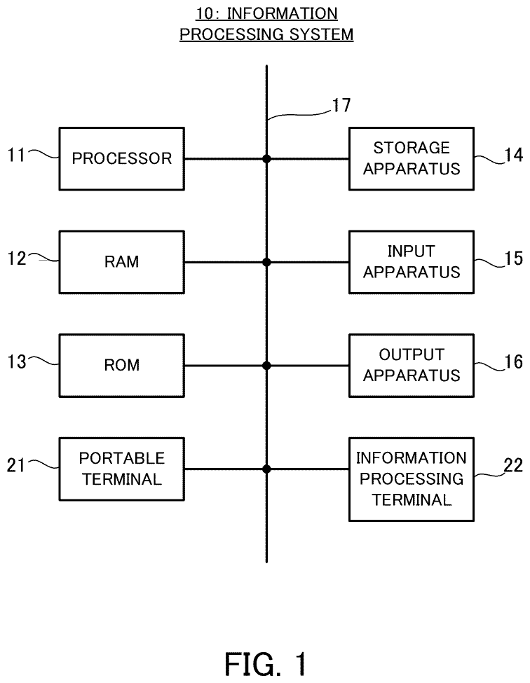

An information processing system according to a first example embodiment will be described with reference to FIG. 1 to FIG. 3.

### (Hardware Configuration)

First, with reference to FIG. 1, a hardware configuration of the information processing system according to the first example embodiment will be described. FIG. 1 is a block diagram illustrating the hardware configuration of the information processing system according to the first example embodiment.

As illustrated in FIG. 1, the information processing system 10 according to the first example embodiment includes a processor 11, a RAM (Random Access Memory) 12, a ROM (Read Only Memory) 13, and a storage apparatus 14. The information processing system 10 may further include an input apparatus 15 and an output apparatus 16. The information processing system 10 also includes a portable terminal 21 and an information processing terminal 22. The processor 11, the RAM 12, the ROM 13, the storage apparatus 14, the input apparatus 15, the output apparatus 16, the portable terminal 21, and the information processing terminal 22 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing system 10, through a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for outputting information indicating a holding state of a portable terminal is realized or implemented in the processor 11. That is, the processor 11 may function as a controller for executing each control in the information processing system 10.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used instead of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Furthermore, another type of non-volatile memory may also be used instead of the ROM 13.

The storage apparatus 14 stores data that are stored by the information processing system 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing system 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing system 10 to the outside. For example, the output apparatus 16 may be a display apparatus (e.g., a display) that is configured to display the information about the information processing system 10. The output apparatus 16 may be a speaker or the like that is configured to audio-output the information about the information processing system 10. The output apparatus 16 may be configured as a portable terminal such as a smartphone and a tablet. The output apparatus 16 may be an apparatus that outputs information in a form other than an image. For example, the output apparatus 16 may be a speaker that audio-outputs the information about the information processing system 10.

The portable terminal 21 is configured as a terminal used by a first user. The portable terminal 21 may be a property of the first user or a terminal lent out to the first user. The portable terminal 21 is configured as a portable terminal that may be carried by the first user, but may be a wearable terminal (i.e., a terminal that is wearable on a part of a body), for example. A more specific configuration and function of the portable terminal 21 will be described in detail later.

The information processing terminal 22 is configured as a terminal used by a second user (i.e., a user who is different from the first user). The information processing terminal 22 is configured as an output destination of information indicating a holding state of the portable terminal 21 (hereinafter referred to as “holding state information” as appropriate). The information processing terminal 22 may be configured to perform various types of processing on the basis of the holding state information on the portable terminal 21. A more specific configuration and function of the information processing terminal 22 will be described in detail later.

Although FIG. 1 illustrates the information processing system 10 including a plurality of apparatuses, all or a part of the functions may be realized or implemented as a single apparatus (information processing apparatus). In such a case, the information processing apparatus may include, for example, only the processor 11, the RAM 12, and the ROM 13. The other components (i.e., the storage apparatus 14, the input apparatus 15, and the output apparatus 16, the portable terminal 21, and the information processing terminal 22) may be provided in an external apparatus connected to the information processing apparatus, for example. In addition, in the information processing apparatus, a part of an arithmetic function may be realized by an external apparatus (e.g., an external server or cloud, etc.).

### (Functional Configuration)

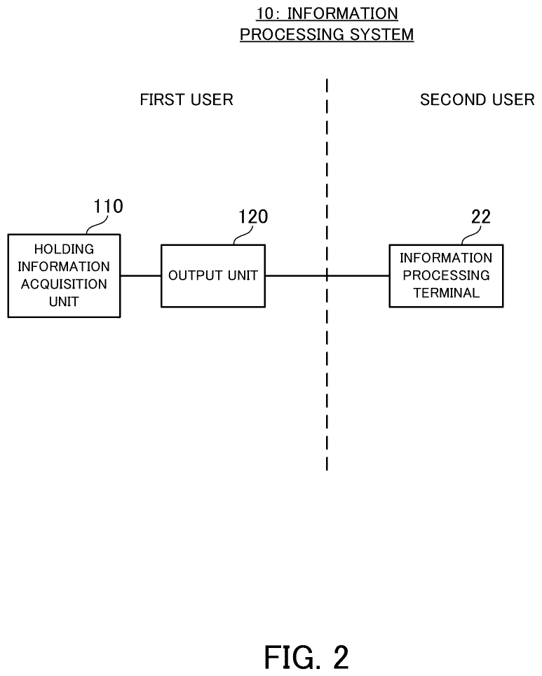

Next, with reference to FIG. 2, a functional configuration of the information processing system 10 according to the first example embodiment will be described. FIG. 2 is a block diagram illustrating the functional configuration of the information processing system according to the first example embodiment.

As illustrated in FIG. 2, the information processing system 10 according to the first example embodiment includes, as components for realizing the functions thereof, a holding information acquisition unit 110, an output unit 120, and the information processing terminal 22 already described. Each of the holding information acquisition unit 110 and the output unit 120 may be a processing block realized or implemented by the processor 11 (see FIG. 1), for example. Alternatively, each of the holding information acquisition unit 110 and the output unit 120 may be provided in the portable terminal 21.

The holding information acquisition unit 110 is configured to acquire the holding state information indicating the holding state of the portable terminal from the portable terminal 21 used by the first user. The “holding state” here may indicate not only whether or not the first user holds the portable terminal 21, but also how the first user holds the portable terminal 21. For example, the holding state information may be information indicating whether or not the first user holds the portable terminal 21 in his/her hand. Alternatively, the holding state information may be information indicating whether or not the first user is wearing the portable terminal 21 in a usable state (e.g., whether or not a wearable terminal is worn on a part of a body). The holding information acquisition unit 110 may acquire the holding state information at preset timing. For example, the holding information acquisition unit 110 may repeatedly acquire the holding state information at predetermined intervals. Alternatively, the holding information acquisition unit 110 may acquire the holding state information at the timing when there is a change in the holding state. Alternatively, the holding information acquisition unit 110 may acquire the holding state information at the timing when the first user holds the portable terminal 21. Alternatively, the holding information acquisition unit 110 may acquire the holding state information at the timing when the first user no longer holds (releases) the portable terminal 21. A method of acquiring the holding state information by the holding information acquisition unit 110 is not particularly limited. The holding information acquisition unit 110 may acquire the holding state information from detection results of various sensors, for example, or may acquire the holding state information by another method.

The output unit 120 is configured to output the holding state information acquired by the holding information acquisition unit 110, to the information processing terminal 22 used by the second user. The output unit 120 may output the holding state information to the information processing terminal 22 through wireless communication, for example. The output unit 120 may output the latest holding state information to the information processing terminal 22 at each time when the holding state information is acquired by the holding information acquisition unit 110. The output unit 120 may be configured to output information other than the holding state information. A specific example of the information other than the holding state information will be described in detail in another example embodiment later.

### (Information Output Operation)

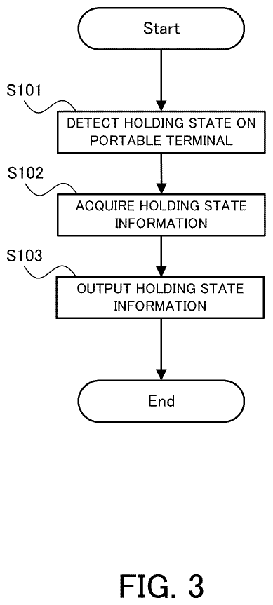

Next, with reference to FIG. 3, a flow of an information output operation by the information processing system 10 according to the first example embodiment (i.e., an operation when outputting the holding state information) will be described. FIG. 3 is a flowchart illustrating the flow of the information output operation by the information processing system according to the first example embodiment.

As illustrated in FIG. 3, in the information output operation by the information processing system 10 according to the first example embodiment, first, the holding state of the portable terminal 21 by the first user is detected on the portable terminal 21 (step S101). Then, the holding information acquisition unit 110 acquires the holding state information from the detection results in the portable terminal 21 (step S102). The holding state information acquired by the holding information acquisition unit 110 is outputted to the output unit 120.

Subsequently, the output unit 120 outputs the holding state information acquired by the holding information acquisition unit 110, to the information processing terminal 22 used by the second user (step S103). In the information processing terminal 22, for example, various types of processing using the holding state information are executed. A series of operation steps described above may be repeated. That is, the acquisition and output of the holding state information may be repeatedly performed.

### Technical Effect

Next, a technical effect obtained by the information processing system 10 according to the first example embodiment will be described.

As described in FIG. 1 to FIG. 3, in the information processing system 10 according to the first example embodiment, the holding state information indicating the holding state of the portable terminal 21 by the first user is acquired, and the holding state information is outputted to the information processing terminal 22 used by the second user. In this way, it is possible to properly output the holding state of the portable terminal 21 by the first user, to the second user. Consequently, for example, the second user can perform various types of processing in the information processing terminal 22, on the basis of the holding state of the portable terminal 21. The various types of processing performed in the information processing terminal 22 will be described in detail in another example embodiment later.

### Second Example Embodiment

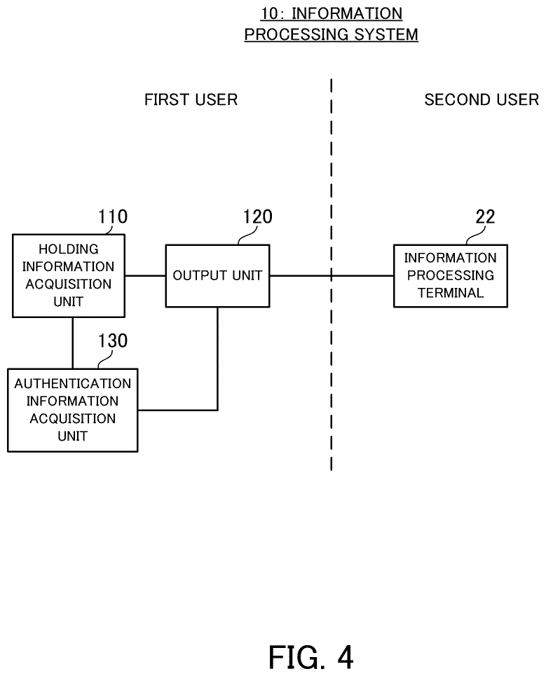

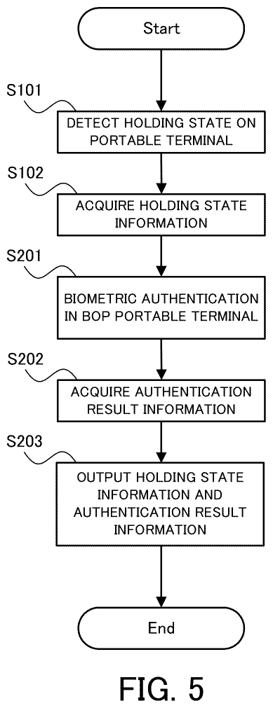

The information processing system 10 according to a second example embodiment will be described with reference to FIG. 4 and FIG. 5. The second example embodiment is partially different from the first example embodiment only in the configuration and operation, and may be the same as the first example embodiment in the other parts. For this reason, a part that is different from the first example embodiment will be described in detail below, and a description of the other overlapping parts will be omitted as appropriate.

### (Functional Configuration)

First, with reference to FIG. 4, a functional configuration of the information processing system 10 according to the second example embodiment will be described. FIG. 4 is a block diagram illustrating the functional configuration of the information processing system according to the second example embodiment. In FIG. 4, the same components as those illustrated in FIG. 2 carry the same reference numerals.

As illustrated in FIG. 4, the information processing system 10 according to the second example embodiment includes, as components for realizing the functions thereof, the holding information acquisition unit 110, the output unit 120, an authentication information acquisition unit 130, and the information processing terminal 22. That is, the information processing system 10 according to the second example embodiment further includes the authentication information acquisition unit 130 in addition to the configuration in the first example embodiment (see FIG. 2). The authentication information acquisition unit 130 may be a processing block realized or implemented by the processor 11 (see FIG. 1), for example. Alternatively, the authentication information acquisition unit 130 may be provided in the portable terminal 21.

The authentication information acquisition unit 130 is configured to acquire authentication result information indicating a result of biometric authentication performed by the portable terminal. A method of the biometric authentication here is not particularly limited, and existing techniques/technologies may be employed as appropriate. For example, the biometric authentication may be otoacoustic/ear acoustic authentication, face authentication, iris authentication, fingerprint authentication, palmprint authentication, voice authentication, vein-pattern authentication, and the like. The biometric authentication may be performed again when the authentication is failed. Even when the authentication is successful once, the authentication may be performed again after a lapse of a predetermined period. In such a case, the authentication information acquisition unit 130 may acquire new authentication information at each time when the biometric authentication is performed.

### (Information Output Operation)

Next, with reference to FIG. 5, a flow of an information output operation by the information processing system 10 according to the second example embodiment will be described. FIG. 5 is a flowchart illustrating the flow of the information output operation by the information processing system according to the second example embodiment. In FIG. 5, the same steps as those illustrated in FIG. 3 carry the same reference numerals.

As illustrated in FIG. 5, in the information output operation by the information processing system 10 according to the second example embodiment, first, the holding state of the portable terminal 21 by the first user is detected on the portable terminal 21 (step S101). Then, the holding information acquisition unit 110 acquires the holding state information from the detection results in the portable terminal 21 (step S102). The holding state information acquired by the holding information acquisition unit 110 is outputted to the output unit 120.

Subsequently, the biometric authentication of the first user is performed in the portable terminal 21 (step S201). Then, the authentication information acquisition unit 130 acquires the authentication result information indicating the result of the biometric authentication in the portable terminal 21 (step S202). The authentication result information acquired by the authentication information acquisition unit 130 is outputted to the output unit 120.

Although described here is an example in which the authentication result information is acquired after the hold state information is acquired, but the hold state information may be acquired after the authentication result information is acquired. Alternatively, the holding state information and the authentication outcome information may be acquired simultaneously and in parallel.

Subsequently, the output unit 120 outputs the holding state information acquired by the holding information acquisition unit 110 and the authentication result information acquired by authentication information acquisition unit 130, to the information processing terminal 22 used by the second user (step S203). The output unit 120 may output the holding state information and the authentication result information simultaneously. In this case, the output unit 120 may output the holding state information and the authentication result information in association with each other. Alternatively, the output unit 120 may output the holding state information and the authentication result information at different timing.

### Technical Effect

Next, a technical effect obtained by the information processing system 10 according to the second example embodiment will be described.

As described in FIG. 4 and FIG. 5, in the information processing system 10 according to the second example embodiment, in addition to the holding state information, the authentication result information indicating the result of the biometric authentication performed by the portable terminal 21 is outputted to the information processing terminal 22 used by the second user. In this way, it is possible to identify the user of the portable terminal 21 on the basis of the authentication result information. Specifically, it is possible to determine whether or not the first user holds the portable terminal 21 (in other words, whether or not another user does not hold the portable terminal 21). Thus, it is possible to prevent injustice or the like due to “spoofing/impersonation”, for example.

### Third Example Embodiment

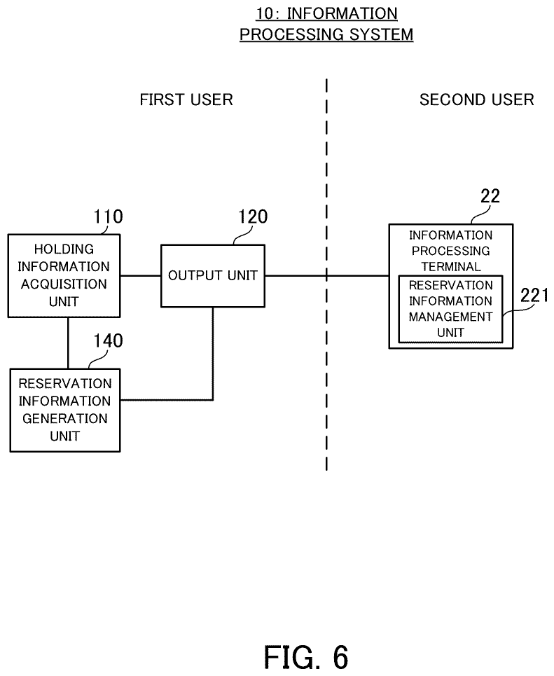

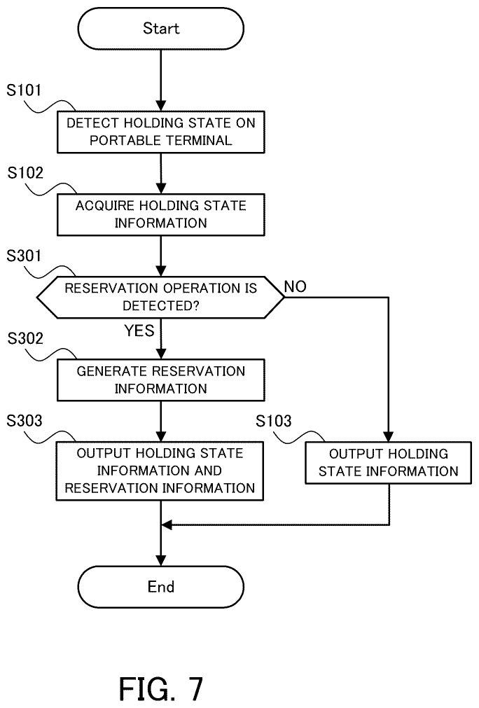

The information processing system 10 according to a third example embodiment will be described with reference to FIG. 6 and FIG. 7. The third example embodiment is partially different from the first and second example embodiments only in the configuration and operation, and may be the same as the first and second example embodiments in the other parts. For this reason, a part that is different from each of the example embodiments described above will be described in detail below, and a description of the other overlapping parts will be omitted as appropriate.

### (Functional Configuration)

First, with reference to FIG. 6, a functional configuration of the information processing system 10 according to the third example embodiment will be described. FIG. 6 is a block diagram illustrating the functional configuration of the information processing system according to the third example embodiment. In FIG. 6, the same components as those illustrated in FIG. 2 carry the same reference numerals.

As illustrated in FIG. 6, the information processing system 10 according to the third example embodiment includes, as components for realizing the functions thereof, the holding information acquisition unit 110, the output unit 120, a reservation information generation unit 140, and the information processing terminal 22. That is, the information processing system 10 according to the third example embodiment further includes the reservation information generation unit 140 in addition to the configuration in the first example embodiment (see FIG. 2). The reservation data generator 140 may be a processing block realized or implemented by the processor 11 (see FIG. 1), for example. Alternatively, the reservation information generation unit 140 may be provided in the portable terminal 21. The information processing terminal 22 according to the third example embodiment includes a reservation information management unit 221.

The reservation information generation unit 140 is configured to generate reservation information about a reservation by the first user. The “reservation” here is a reservation of a service relating to the second user. For example, the reservation information may be a reservation of a facility to which the second user belongs. The reservation information generation unit 140 may generate the reservation information in accordance with an operation by the first user. For example, the reservation information generation unit 140 may generate the reservation information when there is a reservation operation by the first user. Alternatively, the reservation information generation unit 140 may recognize a voice of the first user and may generate the reservation information. Alternatively, the reservation information generation unit 140 may generate the reservation information at the timing when the holding state information is detected. For example, the reservation information generation unit 140 may generate the reservation information at the timing when the first user holds or puts on the portable terminal 21. Alternatively, the reservation information generation unit 140 may generate the reservation information on the basis of the authentication result information described in the second example embodiment. For example, the reservation information generation unit 140 may generate the reservation information at the timing when the biometric authentication succeeds.

The reservation information management unit 221 is configured to manage the reservation information generated by the reservation information generation unit 140. The reservation information management unit 221 may have a function of storing a plurality of pieces of reservation information, for example. The reservation information management unit 221 may have a function of deleting unnecessary pieces of the stored reservation information. The reservation information management unit 221 may have a function of outputting the reservation information to the second user. An example of outputting the reservation information will be described in detail in another example embodiment later.

### (Information Output Operation)

Next, with reference to FIG. 7, a flow of an information output operation by the information processing system 10 according to the third example embodiment will be described. FIG. 7 is a flowchart illustrating the flow of the information output operation by the information processing system according to the third example embodiment. In FIG. 7, the same steps as those illustrated in FIG. 3 carry the same reference numerals.

As illustrated in FIG. 7, in the information output operation by the information processing system 10 according to the second example embodiment, first, the holding state of the portable terminal 21 by the first user is detected on the portable terminal 21 (step S101). Then, the holding information acquisition unit 110 acquires the holding state information from the detection results in the portable terminal 21 (step S102). The holding state information acquired by the holding information acquisition unit 110 is outputted to the output unit 120.

Subsequently, the reservation information generation unit 140 determines whether or not a reservation operation by the second user is detected (step S301). When the reservation operation is not detected (the step S301: NO), the output unit 120 outputs only the holding state information acquired by the holding information acquisition unit 110 (step S103), and a series of processing steps ends.

On the other hand, when the reservation operation is detected (the step S301: YES), the reservation information generation unit 140 generates the reservation information about the reservation by the first user (step S302). The output unit 120 outputs the holding state information acquired by the holding information acquisition unit 110 and the reservation information generated by the reservation information generation unit 140, to the information processing terminal 22 used by the second user (step S303). The output unit 120 may output the holding state information and the reservation information simultaneously. In this case, the output unit 120 may output the holding state information and the reservation information in association with each other. Alternatively, the output unit 120 may output the holding state information and the reservation information at different timing.

### Technical Effect

Next, a technical effect obtained by the information processing system 10 according to the third example embodiment will be described.

As described in FIG. 6 and FIG. 7, in the information processing system 10 according to the third example embodiment, in addition to the holding state information, the reservation information generated by the reservation information generation unit 140 is outputted to the information processing terminal 22 used by the second user. In this way, it is possible to properly output the reservation information about the reservation by the first user, to the second user (e.g., a staff or the like of the reserved facility). In addition, by associating the holding state information with the reservation information, it is possible to properly manage the reservation information on the first user.

### Fourth Example Embodiment

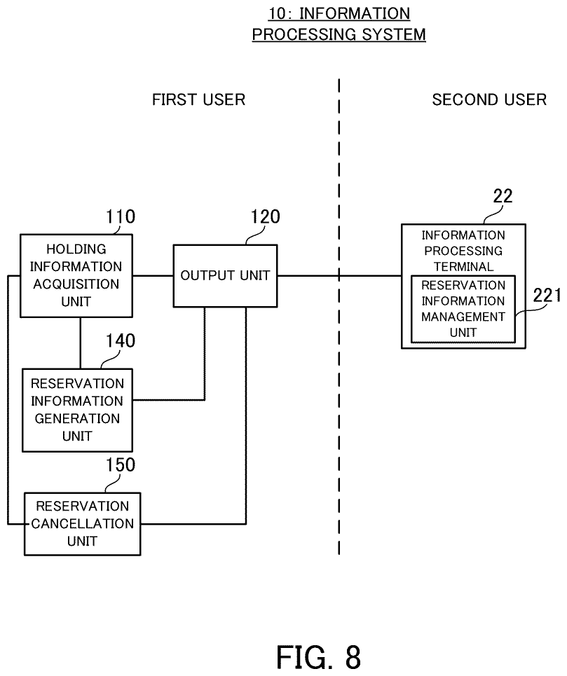

The information processing system 10 according to a fourth example embodiment will be described with reference to FIG. 8 to FIG. 10. The fourth example embodiment is partially different from the third example embodiment only in the configuration and operation, and may be the same as the first to third example embodiments in the other parts. For this reason, a part that is different from each of the example embodiments described above will be described in detail below, and a description of the other overlapping parts will be omitted as appropriate.

### (Functional Configuration)

First, with reference to FIG. 8, a functional configuration of the information processing system 10 according to the fourth example embodiment will be described. FIG. 8 is a block diagram illustrating the functional configuration of the information processing system according to the fourth example embodiment. In FIG. 8, the same components as those illustrated in FIG. 6 carry the same reference numerals.

As illustrated in FIG. 8, the information processing system 10 according to the fourth example embodiment includes, as components for realizing the functions thereof, the holding information acquisition unit 110, the output unit 120, the reservation information generation unit 140, a reservation cancellation unit 150, and the information processing terminal 22. That is, the information processing system 10 according to the fourth example embodiment further includes the reservation cancellation unit 150 in addition to the configuration in the third example embodiment (see FIG. 6). The reservation cancellation unit 150 may be a processing block realized or implemented by the processor 11 (see FIG. 1), for example. Alternatively, the reservation cancellation unit 150 may be provided in the portable terminal 21.

The reservation cancellation unit 150 is configured to cancel the reservation by the first user indicated by the reservation information generated by the reservation information generation unit 140. Specifically, the reservation cancellation unit 150 cancels the reservation by the first user, when the holding state information acquired by the holding information acquisition unit 110 indicates that the portable terminal 21 is not held by the first user. Here, “not held” is a wide concept including not only a state where the first user lets go of the portable terminal 21, but also a state where the first user takes off (removes) the portable terminal 21. When canceling the reservation, the reservation cancellation unit 150 outputs reservation cancellation information to the information processing terminal 22 through the output unit 120. By this, the corresponding reservation information is deleted from the reservation information management unit 221, and the reservation is canceled.

### Modified Example

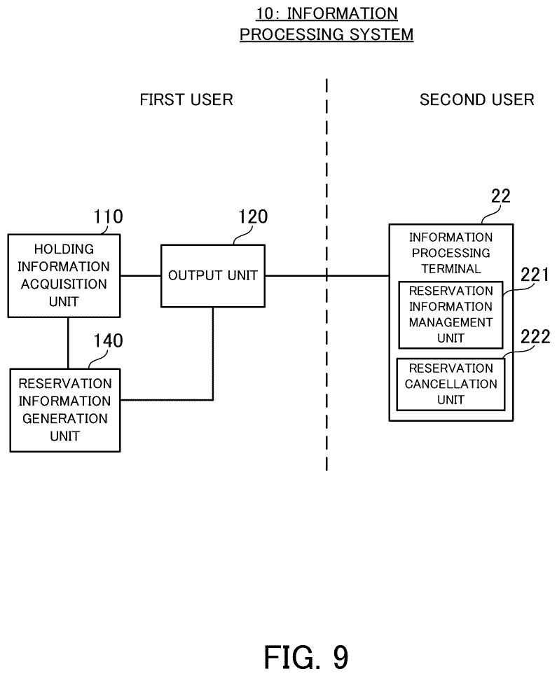

Next, with reference to FIG. 9, a functional configuration of the information processing system 10 according to a modified example of the fourth example embodiment will be described. FIG. 9 is a block diagram illustrating the functional configuration of the information processing system according to the modified example of the fourth example embodiment. In FIG. 9, the same components as those illustrated in FIG. 8 carry the same reference numerals.

As illustrated in FIG. 9, the information processing system 10 according to the modified example of the fourth example embodiment includes, as components for realizing the functions thereof, the holding information acquisition unit 110, the output unit 120, the reservation information generation unit 140, and the information processing terminal 22. In particular, the information processing terminal 22 according to the fourth example embodiment further includes a reservation cancellation unit 222 in addition to the reservation information management unit 221. That is, in the information processing system 10 according to the modified example of the fourth example embodiment, instead of the reservation cancellation unit 150 provided on the first user side in FIG. 8 described above, the reservation cancellation unit 222 is provided in the information processing terminal 22.

As in the reservation cancellation unit 150 illustrated in FIG. 8, the reservation cancellation unit 222 is configured to cancel the reservation by the first user indicated by the reservation information generated by the reservation information generation unit 140. In the configuration in FIG. 9, the output unit 120 outputs only the holding state information to the information processing terminal 22 (i.e., the reservation cancellation information is not outputted as described in FIG. 8). When the holding state information is received, the reservation cancellation unit 222 determines whether or not the portable terminal 21 is held by the first user, and when it is not held, the reservation cancellation unit 222 deletes the corresponding reservation information from the reservation information management unit.

### (Reservation Cancellation Operation)

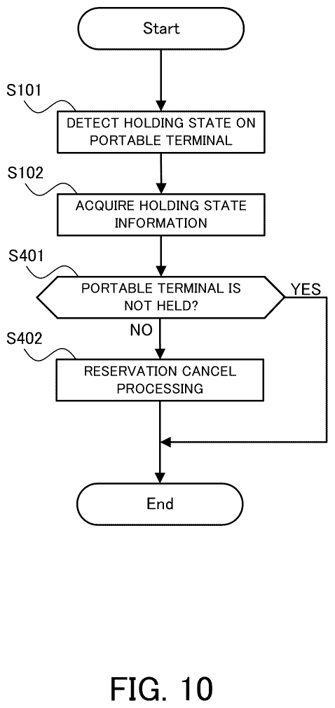

Next, with reference to FIG. 10, a flow of a reservation cancellation operation (i.e., an operation when confirming an intention to continue the reservation and canceling the reservation as appropriate in accordance with a confirmation result) by the information processing system 10 according to the fourth example embodiment will be described. FIG. 10 is a flowchart illustrating the flow of the reservation cancellation operation by the information processing system according to the fourth example embodiment. In FIG. 10, the same steps as those illustrated in FIG. 2 carry the same reference numerals.

As illustrated in FIG. 10, in the reservation cancellation operation by the information processing system 10 according to the fourth example embodiment, first, the holding state of the portable terminal 21 by the first user is detected on the portable terminal 21 (step S101). Then, the holding information acquisition unit 110 acquires the holding state information from the detection results in the portable terminal 21 (step S102).

Subsequently, the reservation cancellation unit 150 or 222 determines whether or not the portable terminal 21 is not held by the first user, on the basis of the holding state information (the step S401). When the portable terminal 21 is not held by the first user (step S401: NO), the reservation cancellation unit 150 or 222 cancels the reservation by the first user (step S402). When the portable terminal 21 is held by the first user (the step S401: YES), the reservation cancellation unit 150 or 222 does not cancel the reservation by the first user (i.e., the step S402 is skipped).

As for the reservation cancellation, for example, considering that a preparation for a product is started after the reservation (e.g., cooking is actually started in a restaurant), a reservation cancelable period may be set. For example, the reservation cancelable period may be set within 10 minutes after the reservation. In this case, if it is within 10 minutes after the reservation, the reservation cancel may be automatically performed on the basis of the holding state information. On the other hand, after 10 minutes or more elapses from the reservation, the reservation cancel may be disabled regardless of the holding state.

### Technical Effect

Next, a technical effect obtained by the information processing system 10 according to the fourth example embodiment will be described.

As described in FIG. 9 and FIG. 10, in the information processing system 10 according to the fourth example embodiment, the reservation by the first user is canceled when the portable terminal 21 is not held by the first user. In this way, it is possible to properly cancel the reservation. Specifically, the first user can communicate/convey an intention to cancel the reservation, by not holding the portable terminal 21 that is held so far. Therefore, it is possible to cancel the reservation without performing a terminal operation or the like for the reservation cancellation.

### Fifth Example Embodiment

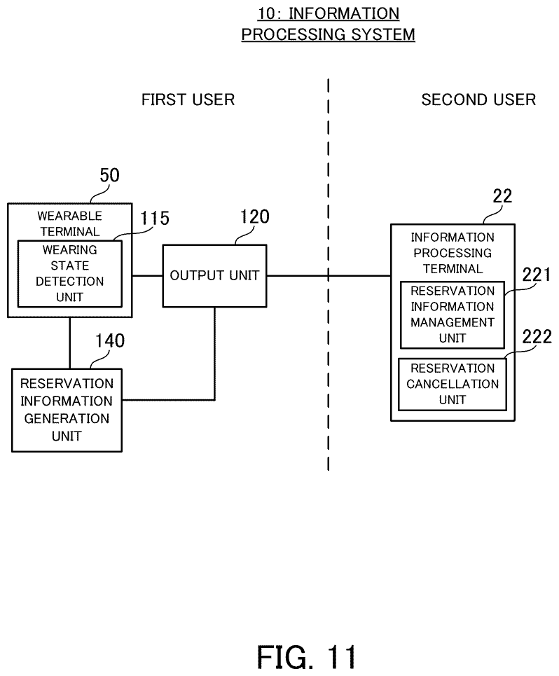

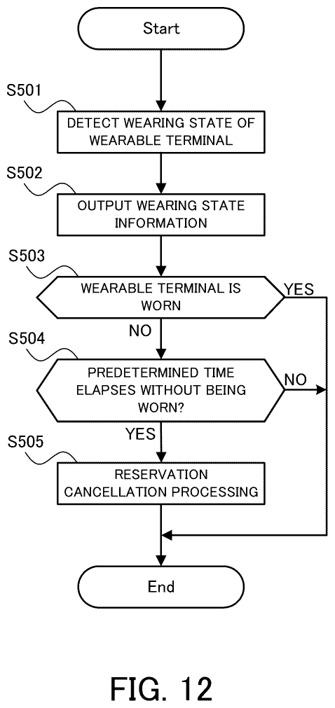

The information processing system 10 according to a fifth example embodiment will be described with reference to FIG. 11 and FIG. 12. The fifth example embodiment is partially different from the fourth example embodiment only in the configuration and operation, and may be the same as the first to fourth example embodiments in the other parts. For this reason, a part that is different from each of the example embodiments described above will be described in detail below, and a description of the other overlapping parts will be omitted as appropriate.

### (Functional Configuration)

First, with reference to FIG. 11, a functional configuration of the information processing system 10 according to the fifth example embodiment will be described. FIG. 11 is a block diagram illustrating the functional configuration of the information processing system according to the fifth example embodiment. In FIG. 11, the same components as those illustrated in FIG. 9 carry the same reference numerals.

As illustrated in FIG. 11, the information processing system 10 according to the fifth example embodiment includes, as components for realizing the functions thereof, a wearable terminal 50, the output unit 120, the reservation information generation unit 140, and the information processing terminal 22. In the configuration illustrated in FIG. 11, the information processing terminal 22 on the second user side includes the reservation cancellation unit 222 as illustrated in FIG. 9, the reservation cancellation unit 150 may be provided on the first user side as illustrated in FIG. 8.

The wearable terminal 50 is a specific example of the portable terminal 21 and is configured as a terminal that is wearable on a part of a body by the first user. A specific type of the wearable terminal 50 is not particularly limited, but may be configured as an earphone type, a watch type (wristband type), or a ring type terminal, for example. The wearable terminal 50 includes a wearing state detection unit 115.

The wearing state detection unit 115 is provided as a specific example of the holding state acquisition unit 110 and is configured to detect whether or not the first user is wearing the wearable terminal 50. The wearing state detection unit 115 may detect that the first user is wearing the wearable terminal 50 by various sensors, for example. Alternatively, the wearable terminal 50 may detect that the first user is wearing the wearable terminal 50, by using the authentication result information (i.e., the result of the biometric authentication) described in the second example embodiment. Specifically, when the biometric authentication is successful (i.e., when the first user is identified by the biometric authentication), it may be detected that the first user is wearing the wearable terminal 50. For example, when the wearable terminal 50 is configured as an earphone type terminal, it may be detected that the first user is wearing the wearable terminal 50, in accordance with a result of otoacoustic/ear acoustic authentication.

### (Reservation Cancellation Operation)

Next, with reference to FIG. 12, a flow of a reservation cancellation operation by the information processing system 10 according to the fifth example embodiment will be described. FIG. 12 is a flowchart illustrating the flow of the reservation cancellation operation by the information processing system according to the fifth example embodiment.

As illustrated in FIG. 12, in the reservation canceling operation by the information processing system 10 according to the fifth example embodiment, first, the wearing state detection unit 115 detects a wearing state of the wearable terminal 50 by the first user (step S501). Thereafter, the wearing state detection unit 115 outputs information indicating the wearing state (wearing state information) to the reservation cancellation unit 222 through the output unit 120 (step S502).

Subsequently, the reservation cancellation unit 222 determines whether or not the wearable terminal 50 is worn by the first user, on the basis of the inputted wearing state information (step S503). When the wearable terminal 50 is worn by the first user (the step S503: YES), the subsequent processing is omitted and a series of operation steps ends.

On the other hand, when the wearable terminal 50 is not worn by the first user (the step S503: NO), the reservation cancellation unit 222 determines whether or not a predetermined time elapses without the wearable terminal 50 being worn (step S504). The “predetermined time” here is a threshold for determining the intention to cancel the reservation by the first user, and is set to exclude a situation where the wearable terminal is unintentionally removed.

When it is determined that the predetermined time elapses without the wearable terminal 50 being worn (the step S504: YES), the reservation cancellation unit 222 cancels the reservation by the first user (step S505). On the other hand, when it is determined that the predetermined time does not elapse without the wearable terminal 50 being worn (the step S504: NO), the reservation cancellation unit 222 does not cancel the reservation by the first user (i.e., the step S505 is skipped).

### Modified Example Relating to Cancel Operation

The above exemplifies a configuration in which the reservation is canceled when the predetermined time elapses from the removal of the wearable terminal 50, but the reservation cancellation operation is not limited to such an example. For example, in addition to or in place of the above configuration, the reservation may be canceled when the first user performs a predetermined operation after removing the wearable terminal 50. An example of the predetermined operation is an operation of holding and shaking the wearable terminal 50 in the hand, for example. This operation may be detected by an acceleration sensor or the like provided in the wearable terminal 50, for example.

### Modified Example Relating to Detection of Wearing state

Whether or not the first user removes the wearable terminal 50 may be detected in cooperation with another wearable terminal. For example, it is assumed that the first user is wearing an earphone as the wearable terminal 50 and is wearing a smartwatch as another wearable terminal. In this case, it may be detected that the earphone is removed, on the basis of an operation detected by the earphone and an operation detected by the smartwatch.

For example, the operation relating to the earphone and the operation relating to the smartwatch are detected by a gyro sensor, an acceleration sensor, or the like mounted on each of the earphone and the smartwatch. When the detected operation relating to the earphone matches the detected operation relating to the smartwatch, it may be detected that the earphone is removed. For example, when the first user holds the earphone with the hand on which the smartwatch is worn, the operation relating to the earphone matches the operation relating to the smartwatch. Therefore, in such a case, it may be detected that the earphone is removed.

Whether or not the operation relating to the earphone matches the operation relating to the smartwatch, may be determined on the smartwatch side by transmitting a detection result of the earphone to the smartwatch, or may be determined on the earphone side by transmitting a detection result of the smartwatch to the earphone. Although described here is an example of detecting that the wearable terminal 50 is removed, it may be detected that the wearable terminal 50 is worn, in the same method.

### Technical Effect

Next, a technical effect obtained by the information processing system 10 according to the fifth example embodiment will be described.

As described in FIG. 11 and FIG. 12, in the information processing system 10 according to the fifth example embodiment, when the wearable terminal is not worn for the predetermined time or more, the reservation by the first user is canceled. In this way, the first user can cancel the reservation simply by removing the wearable terminal 50. Furthermore, since the reservation is canceled after a predetermined time or more elapses from the removal of the wearable terminal 50, it is possible to prevent that the reservation is canceled when the wearable terminal 50 is accidentally removed (i.e., when there is no intention to cancel the reservation).

### Sixth Example Embodiment

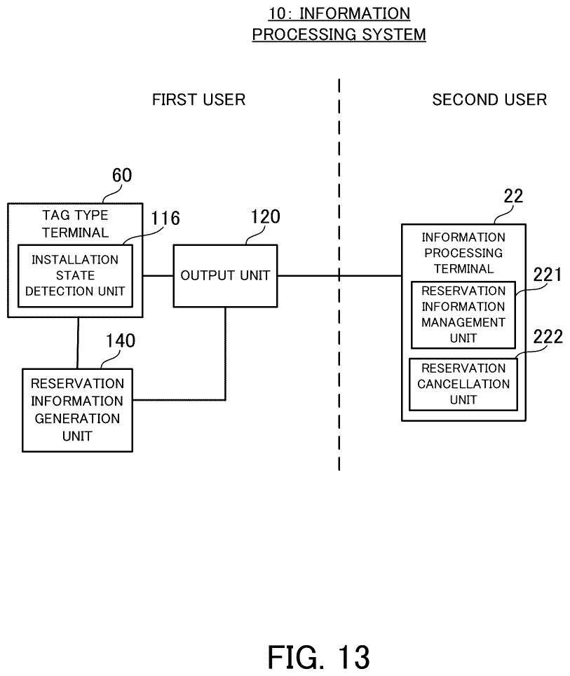

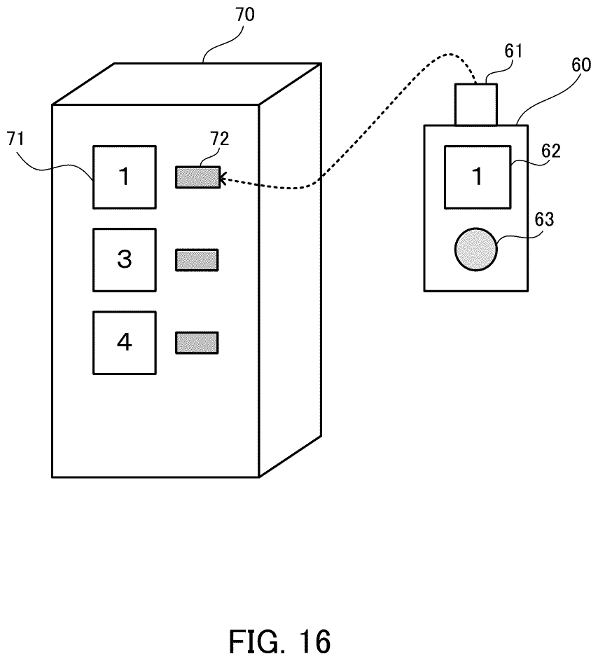

The information processing system 10 according to a sixth example embodiment will be described with reference to FIG. 13 and FIG. 16. The sixth example embodiment is partially different from the fourth example embodiment only in the configuration and operation, and may be the same as the first to fifth example embodiments in the other parts. For this reason, a part that is different from each of the example embodiments described above will be described in detail below, and a description of the other overlapping parts will be omitted as appropriate.

### (Functional Configuration)

First, with reference to FIG. 13, a functional configuration of the information processing system 10 according to the sixth example embodiment will be described. FIG. 13 is a block diagram illustrating the functional configuration of the information processing system according to the sixth example embodiment. In FIG. 13, the same components as those illustrated in FIG. 9 carry the same reference numerals.

As illustrated in FIG. 13, the information processing system 10 according to the sixth example embodiment includes, as components for realizing the functions thereof, a tag type terminal 60, the output unit 120, the reservation information generation unit 140, and the information processing terminal 22. In the configuration illustrated in FIG. 13, the information processing terminal 22 on the second user side includes the reservation cancellation unit 222 as illustrated in FIG. 9, but the reservation cancellation unit 150 may be provided on the first user side as illustrated in FIG. 8.

The tag type terminal 60 is an example of the portable terminal 21 and is configured as a terminal that may be carried by the first user. The tag type terminal 60 is installed in a tag terminal, and may be holdable by pulling out (detaching) it from the tag terminal. An identification number may be added to the tag type terminal 60. The identification number may be added in advance, or may be added when it is held. The tag type terminal 60 includes an installation state detection unit 116.

The installation state detection unit 116 is provided as a specific example of the holding state acquisition unit 110, and is configured to detect an installation state of the tag type terminal 60. Specifically, the installation state detection unit 116 is configured to detect whether the tag type terminal 60 is installed in the tag terminal, or is pulled out. In other words, the installation state detection unit 116 is configured to detect whether or not the first user holds the tag type terminal 60 (whether or not the first user pulls out it from the tag terminal). The installation state of the tag type terminal 60 may be detected by the tag type terminal 60, or may be detected by the tag terminal in which the tag type terminal 60 is installed.

### (Reservation Information Generation Operation)

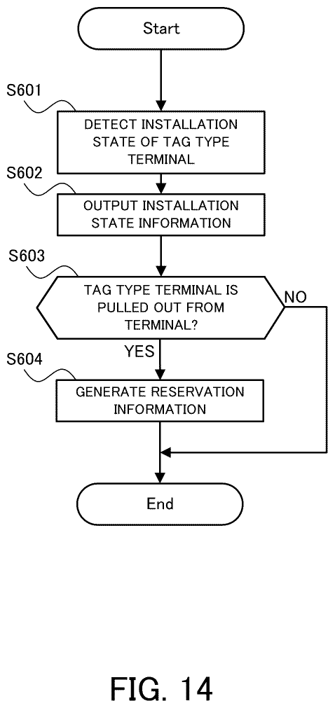

Next, with reference to FIG. 14, a flow of a reservation information generation operation (i.e., an operation when generating the reservation information) by the information processing system 10 according to the sixth example embodiment will be described. FIG. 14 is a flowchart illustrating the flow of the reservation information generation operation by the information processing system according to the sixth example embodiment.

As illustrated in FIG. 14, in the reservation information generation operation by the information processing system 10 according to the sixth example embodiment, first, the installation state detection unit 116 detects the installation state of the tag type terminal 60 in the tag terminal (step S601). Thereafter, the installation state detection unit 116 outputs information indicating the installation state (installation state information) to the reservation information generation unit 140 (step S602).

Subsequently, the reservation information generation unit 140 determines whether or not the tag type terminal 60 is pulled out from the tag terminal, on the basis of the inputted installation state information (step S603). When the tag type terminal 60 is not pulled out from the tag terminal (the step S603: NO), the subsequent processing is omitted, and a series of operation steps ends.

On the other hand, when the tag type terminal 60 is pulled out from the tag terminal (the step S603: YES), the reservation information generation unit 140 generates the reservation information about the reservation by the first user (step S604). That is, it is determined that the first user pulls out the tag type terminal 60 with an intention of the reservation, and new reservation information is generated. The generated reservation information may be outputted to the information processing terminal 22 together with the installation state information, through the output unit 120.

### (Reservation Cancellation Operation)

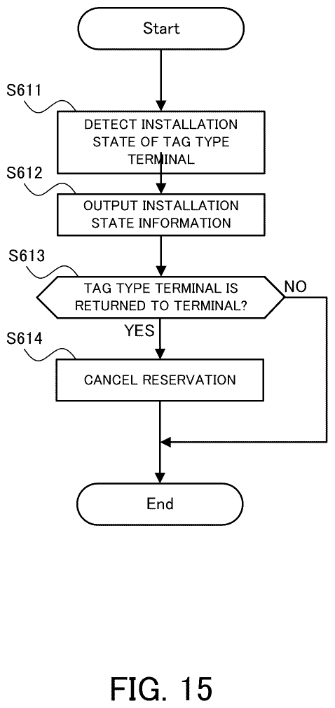

Next, with reference to FIG. 15, a flow of a reservation cancellation operation by the information processing system 10 according to the sixth example embodiment will be described. FIG. 15 is a flowchart illustrating the flow of the reservation cancellation operation by the information processing system according to the sixth example embodiment.

As illustrated in FIG. 15, in the reservation canceling operation by the information processing system 10 according to the sixth example embodiment, first, the installation state detection unit 116 detects the installation state of the tag type terminal 60 in the tag terminal (step S611). Thereafter, the installation state detection unit 116 outputs information indicating the installation state (installation state information) to the reservation cancellation unit 222 (step S612).

Subsequently, the reservation cancellation unit 222 determines whether or not the tag type terminal 60 is returned to the tag terminal, on the basis of the inputted installation state information (step S613). When the tag type terminal 60 is not returned to the tag terminal (the step S613: NO), the subsequent processing is omitted and a series of operation steps ends.

On the other hand, when the tag type terminal 60 is returned to the tag terminal (the step S613: YES), the reservation cancellation unit 222 cancels the reservation by the first user (step S614). That is, it is determined that the first user returns the tag type terminal 60 to the tag terminal with the intention to cancel the reservation, and reservation cancellation processing is performed.

### Specific Configuration Example

Next, with reference to FIG. 16, a specific configuration example of the information processing system 10 according to the sixth example embodiment will be described. FIG. 16 is a schematic diagram illustrating an example of the tag terminal and the tag type terminal in the information processing system according to the sixth example embodiment.

As illustrated in FIG. 16, a tag terminal 70 may be configured to install a plurality of tag type terminals 60. Specifically, the tag terminal 70 may include a plurality of tag dogs 72 in which the tag type terminals 60 are insertable. Each of the plurality of tag dogs 72 may include a terminal display unit 71 that displays the identification number or the like.

The tag type terminal 60 may include a connection terminal 61 for connecting to the tag dog 72, a tag display unit 62 that displays the identification number or the like, and a speaker 63. When the first user pulls out the tag type terminal 60 from the tag dog 72, the reservation information is generated, as already described. At this time, the identification number or the like associated with the reservation information is displayed on the tag display unit 62 of the tag type terminal 60 and the terminal display unit 71 of the tag terminal 70. The speaker 63 of tag type terminal 60 may output audio/voice indicating that it is ready to provide a reserved service, for example. When the first user pulls the tag type terminal 60 from the tag dog 72 and then returns the tag type terminal 60 to the tag dog 72, the reservation is canceled, as already described. The tag type terminal 60 may be returned to the tag dog 72 from which it is pulled out, of the plurality of tag dogs 72, or may be returned to another tag dog 72.

### Technical Effect

Next, a technical effect obtained by the information processing system 10 according to the sixth example embodiment will be described.

As described in FIG. 13 to FIG. 16, in the information processing system 10 according to the sixth example embodiment, the reservation information is generated when the tag type terminal 60 is pulled out from the tag terminal, and the reservation is canceled when it is returned to the tag terminal. In this way, the first user can make a reservation in a simple operation of only pulling out the tag type terminal 60 from the tag terminal 70. Furthermore, the first user can cancel the reservation in a simple operation of only returning the tag type terminal 60 to the tag terminal 70.

### Seventh Example Embodiment

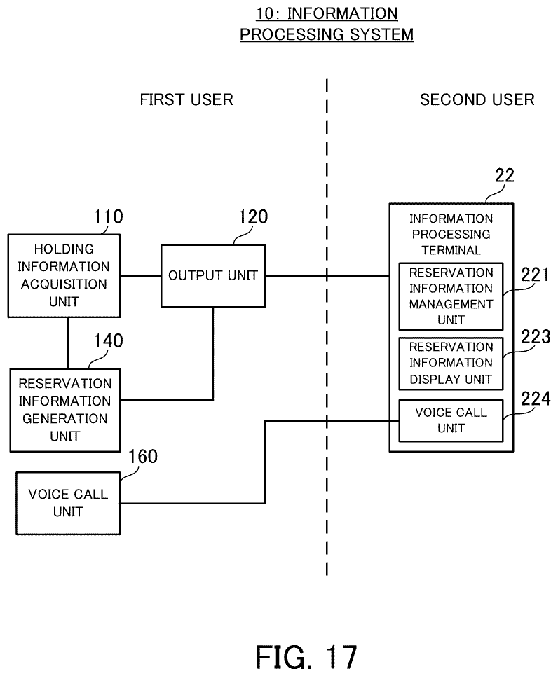

The information processing system 10 according to a seventh example embodiment will be described with reference to FIG. 17 to FIG. 19. The seventh example embodiment is partially different from the third to sixth example embodiments only in the configuration and operation, and may be the same as the first to sixth example embodiments in the other parts. For this reason, a part that is different from each of the example embodiments described above will be described in detail below, and a description of the other overlapping parts will be omitted as appropriate.

### (Functional Configuration)

First, with reference to FIG. 17, a functional configuration of the information processing system 10 according to the seventh example embodiment will be described. FIG. 17 is a block diagram illustrating the functional configuration of the information processing system according to the seventh example embodiment. In FIG. 17, the same components as those illustrated in FIG. 6 carry the same reference numerals.

As illustrated in FIG. 17, the information processing system 10 according to the seventh example embodiment includes, as components for realizing the functions thereof, the holding information acquisition unit 110, the output unit 120, the reservation information generation unit 140, a voice call unit 160, and the information processing terminal 22. That is, the information processing system 10 according to the seventh example embodiment further includes the voice call unit 160 in addition to the configuration in the third example embodiment (see FIG. 6). Furthermore, the information processing terminal 22 according to the seventh example embodiment includes a reservation information display unit 223 and a voice call unit 224, in addition to the reservation information management unit 221. That is, the information processing terminal 22 according to the seventh example embodiment further includes the reservation information display unit 223 and the voice call unit 224, in addition to the configuration in the third example embodiment (see FIG. 6).

The reservation information display unit 223 is configured to display the reservation information on a display or the like. The reservation information display unit 223 may display a plurality of pieces of currently valid reservation information, in a list format. The reservation information display unit 223 is also configured to select the displayed reservation information. For example, the second user may select the reservation information by touching a part of the display where the reservation information is displayed. Alternatively, the second user may select the reservation information by using an input device such as a mouse and a keyboard.

The voice call unit 224 is configured to make a two-way voice call with the first user associated with the selected reservation information. For example, when the reservation information is selected by the second user, first, the voice call unit 224 receives audio input/voice input through a microphone or the like. Then, the voice call unit 224 outputs the inputted audio/voice to the voice call unit 160 on the first user side. The voice call unit 224 is also configured to output the audio/voice inputted by the voice call unit 160 of the first user.

The voice call unit 160 is configured to output the audio/voice outputted from the voice call unit 224 on the second user side. The voice call unit 160 is configured to receive the audio input/voice input by the first user, and to output it to the voice call unit 224 on the second user.

Each of the voice call unit 160 on the first user side and the voice call unit 224 on the second user side may include, for example, a microphone, a speaker, or the like provided as the input apparatus 15 and the output apparatus 16 (see FIG. 1). Alternatively, the voice call units 160 and 224 may include a microphone, a speaker, or the like provided in the portable terminal 21.

The above exemplifies a configuration that allows the two-way voice call between the first user and the second user, but the audio/voice may be outputted only to the first user side from the second user side, for example. That is, the two-way voice call is not a mandatory constituent component. In this case, the first user may communicate/convey his intention to the second user, in a method other than the voice call. For example, the first user may communicate/convey his intention to the second user side, by an operation of the portable terminal 21 (e.g., an operation of selecting one of “yes” and “no”, or an operation of transmitting a message by characters).

### (Reservation Corresponding Operation)

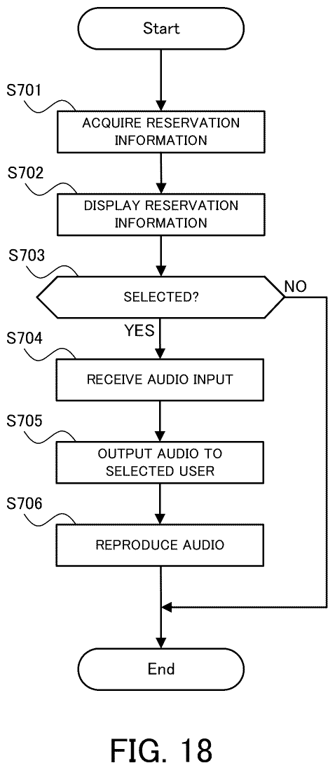

Referring now to FIG. 18, a flow of a reservation corresponding operation (i.e., an operation when the information processing terminal 22 on the second user side acquires the reservation information and performs various types of processing) by the information processing system 10 according to the seventh example embodiment will be described. FIG. 18 is a flowchart illustrating the flow of the reservation corresponding operation by the information processing system according to the seventh example embodiment.

As illustrated in FIG. 18, in the reservation corresponding operation by the information processing system 10 according to the seventh example embodiment, first, the information processing terminal 22 acquires the reservation information outputted from the output unit 120 on the first user side (step S701). The reservation information obtained here is managed by the reservation information management unit 221.

Subsequently, the reservation information display unit 223 displays the reservation information to the second user (step S702). Thereafter, the reservation information display unit 223 determines whether or not the displayed reservation information is selected (step S703). When the reservation information is not selected (the step S703: NO), the subsequent processing may be omitted.

On the other hand, when the reservation information is selected (the step S703: YES), the voice call unit 224 receives the audio input/voice input (step S704). Then, the voice call unit 224 outputs the inputted audio/voice to the voice call unit 160 on the first user side (step S705). Then, the voice call unit 160 reproduces the audio/voice received by the voice call unit 224 on the second user side (step S706). It is not illustrated here, but after the step S706, the voice call unit 160 may receive the audio input/voice input by the first user, and processing of reproducing the audio/voice may be performed in the voice call unit 224 on the second user side. That is, when the reservation data is selected (the step S703: YES), the two-way voice call may be started through the voice call units 160 and 224.

### (Display Example of Reservation Information)

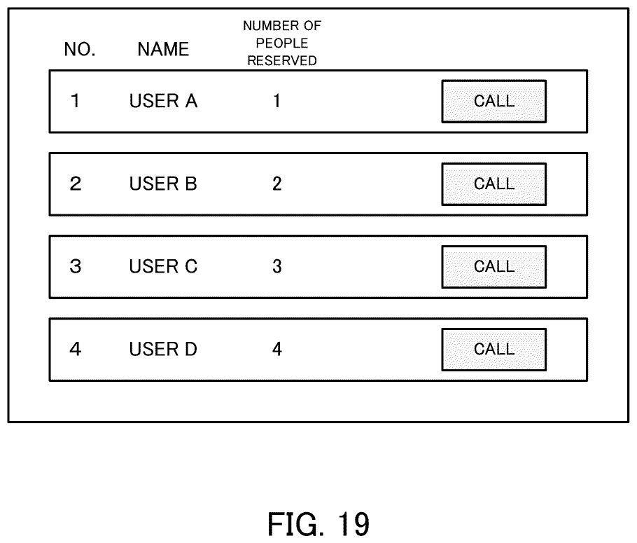

Next, with reference to FIG. 19, a specific display example of the reservation information by the information processing system 10 according to the seventh example embodiment will be described. FIG. 19 is a diagram illustrating a display example of the reservation information in the information processing system according to the seventh example embodiment.

As illustrated in FIG. 19, in the information processing system 10 according to the seventh example embodiment, a plurality of pieces of reservation information are displayed by the reservation information display unit 223. In the example illustrated in the figure, four pieces of reservation information are displayed, for each of which a reservation number, name, and the number of people reserved are displayed. The information displayed here is not particularly limited, and only less pieces of information may be displayed, or more pieces of information may be displayed.

Each of the pieces of reservation information is also displayed with a call button. When the call button is pressed, audio/voice may be outputted to the first user. For example, the second user may output audio/voice for notifying the first user that a reserved product is ready. Alternatively, the second user may output audio/voice for confirming whether the reservation is really to be cancelled, when the operation of canceling the reservation by the first user (e.g., the operation of removing the wearable terminal described above) is performed. In this case, the reservation may not be canceled automatically, and after confirmed, the reservation may be canceled by the operation of the second user.

### Technical Effect

Next, a technical effect obtained by the information processing system 10 according to the seventh example embodiment will be described.

As described in FIG. 17 to FIG. 19, in the information processing system 10 according to the seventh example embodiment, the reservation information is displayed on the information processing terminal 22 on the second user side. When the second user selects the displayed reservation information, it is possible to output audio/voice to the selected first user. In this way, the second user can make a voice contact with the first user who makes a reservation, by a simple operation, after grasping a current reservation state.

### Eighth Example Embodiment

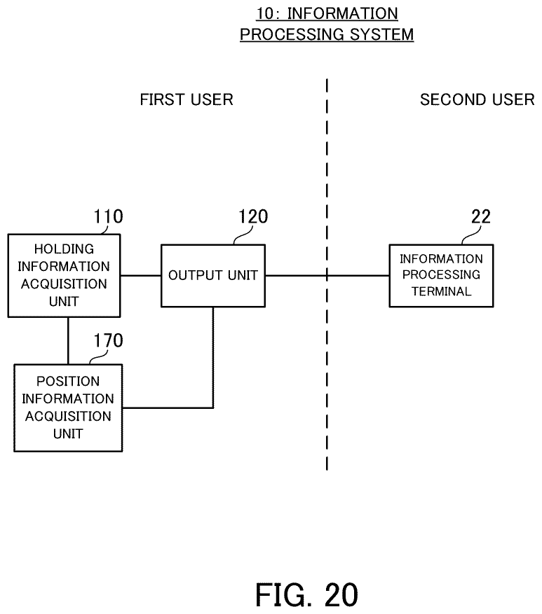

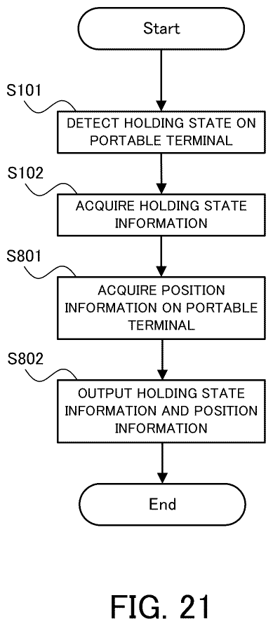

The information processing system 10 according to an eighth example embodiment will be described with reference to FIG. 20 and FIG. 21. The eighth example embodiment is partially different from the first to seventh example embodiments only in the configuration and operation, and may be the same as the first to seventh example embodiments in the other parts. For this reason, a part that is different from each of the example embodiments described above will be described in detail below, and a description of the other overlapping parts will be omitted as appropriate.

### (Functional Configuration)

First, with reference to FIG. 20, a functional configuration of the information processing system 10 according to the eighth example embodiment will be described. FIG. 20 is a block diagram illustrating the functional configuration of the information processing system according to the eighth example embodiment. In FIG. 20, the same components as those illustrated in FIG. 2 carry the same reference numerals.

As illustrated in FIG. 20, the information processing system 10 according to the eighth example embodiment includes, as components for realizing the functions thereof, the holding information acquisition unit 110, the output unit 120, a position information acquisition unit 170, and the information processing terminal 22. That is, the information processing system 10 according to the eighth example embodiment further includes the position information acquisition unit 170 in addition to the configuration in the first example embodiment (see FIG. 2). The position information acquisition unit 170 may be a processing block realized or implemented by processor 11 (see FIG. 1), for example. Alternatively, the positional informing acquisition unit 170 may be provided in the portable terminal 21.

The position information acquisition unit 170 is configured to acquire position information indicating a position of the portable terminal 21 (in other words, the position information on a position of the first user holding the portable terminal 21). A method of acquiring the positional information is not particularly limited, but the positional information acquisition unit 170 may acquire the positional information by using a GPS (Global Positioning System) installed in the portable terminal 21, for example. The position information acquisition unit 170 may acquire the position information, for example, on the basis of the holding state information acquired by the holding information acquisition unit 110. For example, the position information acquisition unit 170 may acquire the position information at the timing when it is determined that the first user holds the portable terminal 21, on the basis of the holding state information. The position information acquisition unit 170 may continue to acquire the position information while the first user holds the portable terminal 21. That is, processing of tracking the position of the first user may be performed. The position information acquired by the position information acquisition unit 170 is configured to be outputted to the information processing terminal 22 on the second user side through the output unit 120.

### (Information Output Operation)

Next, with reference to FIG. 21, a flow of an information output operation by the information processing system 10 according to the eighth example embodiment will be described. FIG. 21 is a flowchart illustrating the flow of the information output operation by the information processing system according to the eighth example embodiment. In FIG. 21, the same steps as those illustrated in FIG. 3 carry the same reference numerals.

As illustrated in FIG. 21, in the information output operation by the information processing system 10 according to the eighth example embodiment, first, the holding state of the portable terminal 21 by the first user is detected on the portable terminal 21 (step S101). Then, the holding information acquisition unit 110 acquires the holding state information from the detection results in the portable terminal 21 (step S102). The holding state information acquired by the holding information acquisition unit 110 is outputted to the output unit 120.

Subsequently, the position information acquisition unit 170 acquires the position information on the first user holding the portable terminal 21 (step S801). The position information acquired by the positional information acquisition unit 170 is outputted to the output unit 120.

Although described here is an example in which the position information is acquired after the holding state information is acquired, but the holding state information may be acquired after the position information is acquired. Alternatively, the holding state information and the position information may be acquired simultaneously and in parallel.

Subsequently, the output unit 120 outputs the holding state information acquired by the holding information acquisition unit 110 and the position information acquired by the position information acquisition unit 170, to the information processing terminal 22 used by the second user (step S802). The output unit 120 may output the holding state information and the position information simultaneously. In this case, the output unit 120 may output the holding state information and the position information in association with each other. Alternatively, the output unit 120 may output the holding state information and the position information at different timing.

### Technical Effect

Next, a technical effect obtained by the information processing system 10 according to the eighth example embodiment will be described.

As described in FIG. 20 and FIG. 21, in the information processing system 10 according to the eighth example embodiment, in addition to the holding state information, the position information on the first user is outputted to the information processing terminal 22 used by the second user. In this way, the second user can understand where the first user holding the portable terminal 21 is located. Thus, for example, the second user can perform various types of processing using the position information on the first user. Specific processing on the second user side using the position information will be described in detail in another example embodiment below.

### Ninth Example Embodiment

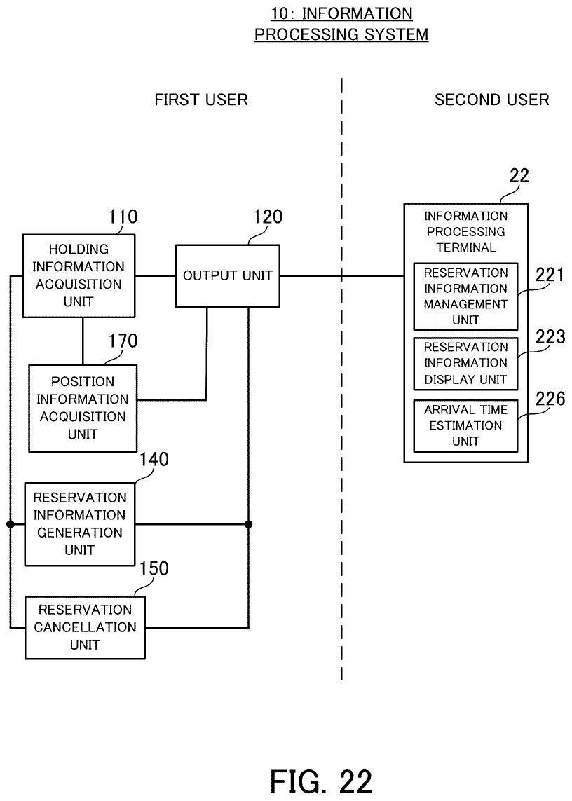

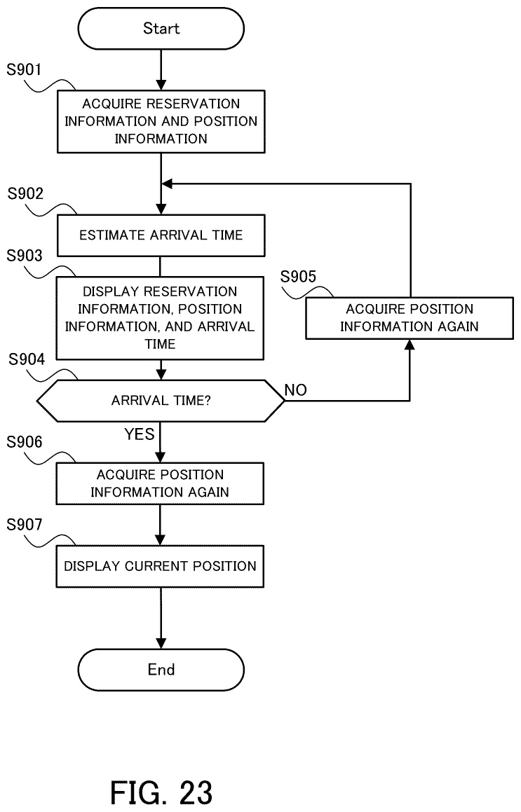

The information processing system 10 according to a ninth example embodiment will be described with reference to FIG. 22 and FIG. 23. The ninth example embodiment is partially different from the eighth example embodiment only in the configuration and operation, and may be the same as the first to eighth example embodiments in the other parts. For this reason, a part that is different from each of the example embodiments described above will be described in detail below, and a description of the other overlapping parts will be omitted as appropriate.

### (Functional Configuration)

First, with reference to FIG. 22, a functional configuration of the information processing system 10 according to the ninth example embodiment will be described. FIG. 22 is a block diagram illustrating the functional configuration of the information processing system according to the ninth example embodiment. In FIG. 22, the same components as those illustrated in FIG. 20 carry the same reference numerals.

As illustrated in FIG. 22, the information processing system 10 according to the ninth example embodiment includes, as components for realizing the functions thereof, the holding information acquisition unit 110, the output unit 120, the reservation information generation unit 140, the reservation cancellation unit 150, the position information acquisition unit 170, and the information processing terminal 22. That is, the information processing system 10 according to the ninth example embodiment further includes the reservation information generation unit 140 and the reservation cancellation unit 150, in addition to the configuration in the eighth example embodiment (see FIG. 20). The reservation information generation unit 140 and the reservation cancellation unit 150 may be the same as those described in the fourth example embodiment. Furthermore, in the configuration illustrated in FIG. 22, the reservation cancellation unit is provided on the first user side as illustrated in FIG. 8, but the information processing terminal 22 on the second user side may include the reservation cancellation unit 222 as illustrated in FIG. 9.

The information processing terminal 22 according to the ninth example embodiment includes an arrival time estimation unit 226, in addition to the reservation information management unit 221 and the reservation information display unit 223 already described. The arrival time estimation unit 226 is configured to estimate an arrival time of the first user (e.g., a time when the first user arrives at a facility to which the second user belongs) by using the position information acquired by the position information acquisition unit 170. A method of estimating the arrival time is not particularly limited, but the arrival time may be estimated by using an existing navigation apparatus, for example. The arrival time may be estimated as a value with some range, for example “arrive at 12:00 to 12:30”. The arrival time estimated by the arrival time estimation unit 226 may be displayed on the reservation information display unit 223. Alternatively, the arrival time estimated by the arrival time estimation unit 226 may be audio-outputted by using a speaker or the like.

### (Reservation Corresponding Operation)

Next, with reference to FIG. 23, a flow of a reservation corresponding operation by the information processing system 10 according to the ninth example embodiment will be described. FIG. 23 is a flowchart illustrating the flow of the reservation corresponding operation by the information processing system according to the ninth example embodiment.

As illustrated in FIG. 23, in the reservation corresponding operation by the information processing system 10 according to the ninth example embodiment, first, the information processing terminal 22 acquires the reservation information on the first user generated by the reservation information generation unit 140, and the position information on the first user acquired by the position information acquisition unit 170 (step S901).

Subsequently, the arrival time estimation unit 226 estimates the arrival time of the first user on the basis of the position information (step S902). Then, the reservation information display unit 223 displays the reservation information, the position information, and the estimated arrival time, for the second user (step S903).

Subsequently, the arrival time estimation unit 226 determines whether or not a current time is the estimated arrival time (step S904). Here, when it is not yet the arrival time (the step S904: NO), the position information acquisition unit 170 acquires the position information again (step S905), and then processing after the step S902 is repeated. That is, the arrival time is estimated on the basis of the newly acquired position information, and the reservation information, the position information, and the estimated arrival time are displayed (updated).

On the other hand, when it is the arrival time, the position information acquisition unit 170 acquires the position information again (step S906), and the reservation information display unit 223 displays a present position of the first user, for the second user (step S907). That is, the reservation information display unit 223 displays information indicating where the first user who has arrived is actually located. As a result, the second user performs an action corresponding to an arrived position of the first user. For example, in a case where the first user makes a reservation for a takeout at a restaurant to which the second user belongs, the second user may deliver a product to a position where the first user has arrived (e.g., a parking lot, etc.). When an accurate position of the first user is hardly grasped only by the position information, the position of the first user may be identified by the two-way voice call through the voice call units 160 and 224 (see FIG. 17) described in the seventh example embodiment, for example.

### Technical Effect

Next, a technical effect obtained by the information processing system 10 according to the ninth example embodiment will be described.

As described in FIG. 20 and FIG. 21, in the information processing system 10 according to the eighth example embodiment, the arrival time is estimated by using the position information. In this way, the second user can grasp the arrival time of the first user, and it is thus possible to properly provide a service reserved by the first user. For example, since the second user can prepare in accordance with the arrival time of the first user (e.g., at a restaurant, a meal can be prepared in accordance with the arrival time), it is possible to provide the service to the first user, more properly.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal.

### <Supplementary Notes>

The example embodiments described above may be further described as, but not limited to, the following Supplementary Notes below.

### (Supplementary Note 1)

An information processing system according to Supplementary Note 1 is an information processing system including: a holding information acquisition unit that acquires, from a portable terminal used by a first user, holding state information indicating a holding state of the portable terminal; and an output unit that outputs the holding state information to an information processing terminal used by a second user who is different from the first user.

### (Supplementary Note 2)

An information processing system according to Supplementary Note 2 is the information processing system according to Supplementary Note 1, further including an authentication information acquisition unit that acquires, from the portable terminal, authentication result information indicating a result of biometric authentication performed by the portable terminal, wherein the output unit outputs the holding state information and the authentication result information to the information processing terminal used by the second user.

### (Supplementary Note 3)

An information processing system according to Supplementary Note 3 is the information processing system according to Supplementary Note 1 or 2, further including a reservation information generation unit that generates reservation information about a reservation by the first user, wherein the output unit outputs the holding state information and the reservation information to the information processing terminal used by the second user.

### (Supplementary Note 4)

An information processing system according to Supplementary Note 4 is the information processing system according to Supplementary Note 3, further including a cancellation unit that cancels the reservation by the first user indicated by the reservation information, when the holding state information indicates that the portable terminal is not held by the first user.

### (Supplementary Note 5)

An information processing system according to Supplementary Note 5 is the information processing system according to Supplementary Note 4, wherein the portable terminal is a wearable terminal, the holding information acquisition unit acquires information indicating whether or not the first user is wearing the wearable terminal, as the holding state information, and the cancellation unit cancels the reservation by the first user when the wearable terminal is not worn for a predetermined time or more.

### (Supplementary Note 6)

An information processing system according to Supplementary Note 6 is the information processing system according to Supplementary Note 4, wherein the portable terminal is a tag type terminal installed in a tag terminal, the holding information acquisition unit acquires information indicating whether or not the tag type terminal is pulled out from the tag terminal, as the holding state information, the reservation information generation unit generates the reservation information when the tag type terminal is pulled out from the tag terminal, and the cancellation unit cancels the reservation when the tag type terminal is returned to the tag terminal.

### (Supplementary Note 7)

An information processing system according to Supplementary Note 7 is the information processing system according to any one of Supplementary Notes 3 to 6, further including: a display unit that displays the reservation information, for the second user; and an audio output unit that outputs audio to the first user when the second user selects the reservation information displayed on the display unit, wherein the first user is associated with the selected reservation information.

### (Supplementary Note 8)

An information processing system according to Supplementary Note 8 is the information processing system according to any one of Supplementary Notes 1 to 7, further including a position information acquisition unit that acquires position information indicating a position of the first user, wherein the output unit outputs the holding state information and the position information to the information processing terminal used by the second user.

### (Supplementary Note 9)

An information processing method according to Supplementary Note 9 is an information processing method that is executed by at least one computer, the information processing method including: acquiring, from a portable terminal used by a first user, holding state information indicating a holding state of the portable terminal; and outputting the holding state information to an information processing terminal used by a second user who is different from the first user.

### (Supplementary Note 10)

A recording medium according to Supplementary Note 10 is a recording medium on which a computer program that allows at least one computer to execute an information processing method is recorded, the information processing method including: acquiring, from a portable terminal used by a first user, holding state information indicating a holding state of the portable terminal; and outputting the holding state information to an information processing terminal used by a second user who is different from the first user.

### (Supplementary Note 11)

A computer program according to Supplementary Note 10 is a computer program that allows at least one computer to execute an information processing method, the information processing method including: acquiring, from a portable terminal used by a first user, holding state information indicating a holding state of the portable terminal; and outputting the holding state information to an information processing terminal used by a second user who is different from the first user.

### (Supplementary Note 12)

An information processing apparatus according to Supplementary Note 12 is an information processing apparatus including: a holding information acquisition unit that acquires, from a portable terminal used by a first user, holding state information indicating a holding state of the portable terminal; and an output unit that outputs the holding state information to an information processing terminal used by a second user who is different from the first user.

This disclosure is allowed to be changed, if desired, without departing from the essence or spirit of this disclosure which can be read from the claims and the entire specification. An information processing apparatus, an information processing method, and a recording medium with such changes are also intended to be within the technical scope of this disclosure.

### DESCRIPTION OF REFERENCE CODES

10 Information processing system
11 Processor
16 Out apparatus
21 Portable terminal
22 Information processing terminal
50 Wearable terminal
60 Tag type terminal
61 Connection terminal
62 Tag display unit
63 Speaker
70 Tag terminal
71 Terminal display unit
72 Tag dog
110 Holding information acquisition unit
115 Wearing state detection unit
116 Installation state detection unit
120 Output unit
130 Authentication information acquisition unit
140 Reservation information generation unit
150 Reservation cancellation unit
160 Voice call part
170 Location acquisition unit
221 Reservation Information Management Department
222 Reservation cancellation unit
223 Reservation information display
224 Voice speech unit
226 Arrival time estimation unit

What is claimed is:

1. An information processing system comprising:
at least one memory that is configured to store instructions; and
at least one processor that is configured to execute the instructions to:
acquire, from a portable terminal used by a first user, holding state information indicating a holding state of the portable terminal; and
outputs the holding state information to an information processing terminal used by a second user who is different from the first user.

2. The information processing system according to claim 1, wherein the at least one processor that is configured to execute the instructions to:
acquire, from the portable terminal, authentication result information indicating a result of biometric authentication performed by the portable terminal; and
outputs the holding state information and the authentication result information to the information processing terminal used by the second user.

3. The information processing system according to claim 1, wherein the at least one processor that is configured to execute the instructions to:
generate reservation information about a reservation by the first user; and
outputs the holding state information and the reservation information to the information processing terminal used by the second user.

4. The information processing system according to claim 3, wherein the at least one processor that is configured to execute the instructions to cancel the reservation by the first user indicated by the reservation information, when the holding state information indicates that the portable terminal is not held by the first user.

5. The information processing system according to claim 4, wherein
the portable terminal is a wearable terminal, and
the at least one processor that is configured to execute the instructions to:
acquire information indicating whether or not the first user is wearing the wearable terminal, as the holding state information; and
cancel the reservation by the first user when the wearable terminal is not worn for a predetermined time or more.

6. The information processing system according to claim 4, wherein
the portable terminal is a tag type terminal installed in a tag terminal, and
the at least one processor that is configured to execute the instructions to:
acquire information indicating whether or not the tag type terminal is pulled out from the tag terminal, as the holding state information;
generate the reservation information when the tag type terminal is pulled out from the tag terminal; and
cancel the reservation when the tag type terminal is returned to the tag terminal.

7. The information processing system according to claim 3, wherein the at least one processor that is configured to execute the instructions to:
display the reservation information, for the second user; and
output audio to the first user when the second user selects the reservation information displayed, wherein the first user is associated with the selected reservation information.

8. The information processing system according to claim 1, wherein the at least one processor that is configured to execute the instructions to:
acquire position information indicating a position of the first user; and
output the holding state information and the position information to the information processing terminal used by the second user.

9. An information processing method that is executed by at least one computer, the information processing method comprising:
acquiring, from a portable terminal used by a first user, holding state information indicating a holding state of the portable terminal; and
outputting the holding state information to an information processing terminal used by a second user who is different from the first user.

10. A non-transitory recording medium on which a computer program that allows at least one computer to execute an information processing method is recorded, the information processing method including:
acquiring, from a portable terminal used by a first user, holding state information indicating a holding state of the portable terminal; and
outputting the holding state information to an information processing terminal used by a second user who is different from the first user.
